(19) United States
(12) Patent Application Publication
(10) Pub. No.: US 2006/0104278 A1
(43) Pub. Date: May 18, 2006

(54) Apparatus and method for compressing headers in a broadband wireless communication system

(75) Inventors: Yong Chang, Seongnam-si (KR); Hong-Sung Chang, Suwon-si (KR); Geun-Hwi Lim, Seongnam-si (KR); Jun-Hyung Kim, Suwon-si (KR); Dong-Ho Cho, Daejeon (KR); Jee-Young Song, Daejeon (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/273,018

(22) Filed: Nov. 15, 2005

(30) Foreign Application Priority Data
Nov. 15, 2004 (KR) 93282/2004

(51) Int. Cl. H04L 12/56

(52) U.S. Cl. 370/392

(57) ABSTRACT

A transmission apparatus and method for compressing headers in a broadband wireless communication system are provided. Upon receiving a packet to which a real-time transport protocol (RTP) header, a user datagram protocol (UDP) header, and an Internet protocol (IP) header are added, from an upper layer, a header compression protocol layer transmits the received packet without compressing the headers at initial transmission, and from the next transmission, compresses the headers according to a compression scheme provided in Internet technology. A header compression convergence sublayer classifies the packet according to initial-header information received from the header compression protocol layer, stores mapping information for the packet classification, and performs packet classification on a header-compressed packet using the mapping information.

### CROSS-REFERENCE TO RELATED APPLICATIONS

This application claims the benefit under 35 U.S.C. § 119(a) of a Korean Patent Application Serial No. 2004-93282 filed in the Korean Intellectual Property Office on Nov. 15, 2004, the entire contents of which are hereby incorporated by reference.

### BACKGROUND OF THE INVENTION

1. Field of the Invention

The present invention relates generally to an apparatus and method for compressing headers in a wireless communication system. In particular, the present invention relates to an apparatus and method for compressing headers in a broadband wireless communication system.

2. Description of the Related Art

Generally, a wireless communication system provides a method for enabling a user to perform communication using a subscriber station (SS) regardless of place. The wireless communication system has been developed to accommodate a plurality of users using various multiple access schemes. A Code Division Multiple Access (CDMA) scheme is the typical multiple access scheme used for the wireless communication system. The CDMA scheme has evolved from an early version for voice communication into the latest version for high-speed data processing. The development of the CDMA scheme is in part due to the increasing users'demands for high-speed data transmission and the rapid progress of communication technology. With the development of its technology, the CDMA scheme has now been adopted as a standard for most 3^{rd} generation (3G) mobile communication systems, and has entered its commercialization phase.

However, the CDMA scheme has limitations in transmitting data at a higher rate due to its limited resources. Nevertheless, the data rate required by users shows a tendency to increase. Therefore, in the wireless communication field, various researches and attempts are being made to transmit data at the higher rate.

As an example, research is now being conducted on an Orthogonal Frequency Division Multiple Access (OFDMA) scheme based on the broadband wireless communication technique. The OFDMA scheme configures a plurality of channels using orthogonal frequencies, and allocates one or more channels to the individual users for data transmission. An IEEE 802.16 system is the typical system based on the OFDMA scheme.

In the IEEE 802.16 system, originally aimed at providing high-speed data service, most researches are being conducted on a method for providing data service. However, the wireless communication system provides voice service as its basic communication service. Therefore, the IEEE 802.16 system is also allowed to provide voice service based on an Internet Protocol (IP). A description will now be made of a protocol configuration for providing IP-based voice service in the IEEE 802.16 system.

FIG. 1 is a diagram illustrating a protocol configuration for a wireless communication network for providing IP-based packet voice service in an IEEE 802.16 system. With reference to FIG. 1, a description will now be made of a protocol configuration for a wireless communication network for providing IP-based packet voice service in an IEEE 802.16 system.

The protocol configuration will be described from its upper layer. Data delivered from a Multimedia Applications layer to its lower layers, as illustrated in FIG. 1, includes voice, video and text data. Such data, which is pure data, is configured in payload formats 108 and then delivered to a Real-time Transport Protocol (RTP) layer 107. Then the RTP layer 107 adds an RTP header to the received payload format data, and provides the RTP header-added data to a User Datagram Protocol (UDP) layer 106. An RTP Control Protocol (RTCP) layer 109 serves to provide control information of the RTP layer 107. The UDP layer 106 converts the collected data into UDP format data, adding a UDP header thereto. The UDP header-added data is delivered to an IP layer 105, and the IP layer 105 further adds an IP header thereto and delivers the IP header-added data to a Convergence Sublayer service Access Point (CS-SAP) 104.

The CS-SAP 104 delivers the received data to a convergence sublayer (CS) 103. The convergence sublayer 103 classifies packets received from its upper layers according to predetermined criteria. The criteria used for the packet classification include an IP address of a transmitter, an IP address of a receiver, a UDP port, an IP service type, and so on. Theses values are included in the IP and UDP headers, and the convergence sublayer 103 extracts these values from a packet data unit (PDU) provided from the upper layers, and uses the extracted values for packet classification. After classification of the received packets, the convergence sublayer 103 maps the classified packets to their appropriate flows, adds connection identifiers (IDs) thereto, and delivers the connection ID-added packets to its lower Medium Access Control (MAC) sublayer 101 via a MAC-Service Access Point (MAC-SAP) 102.

In the foregoing protocol configuration, a process of receiving data and processing the received data is performed in the reverse process of the foregoing process.

Header fields of such upper layers as the IP layer 105, the UDP layer 106, and the RTP layer 107 include the values determined during call setup, which remain unchanged until the call ends. Therefore, it is possible that these values are stored both in the transmitter and the receiver, and in a wireless section, only the values varying for every packet are transmitted excluding these values. In this case, the receiver restores a received packet with the previously stored values, thereby reconfiguring its original header. In this manner, the receiver is not required to read the header information, thus reducing the amount of data transmitted in the wireless section. The reason for reducing the header information is as follows.

In a voice codec, 20-byte data is generated every frame. However, the amount of header information added through the RTP layer 107, the UDP layer 106 and the IP layer 105 is 40 bytes. Therefore, a size of the header is two times the size of the actual transmission voice data. Accordingly, it is very important to reduce a length of the header in order to improve resource efficiency in the wireless section.

In order to reduce a length of a header, the current 802.16 standard defines a Payload Header Suppression (PHS) scheme for transmitting only the remaining part, from which a header of the corresponding part is excluded according to a rule predetermined during call setup, in the wireless section.

The PHS scheme will now be described below. In the protocol configuration of FIG. 1, the convergence sublayer 103 is a protocol interposed between its upper layers such as the MAC sublayer 101 and the IP layer 105. The convergence sublayer 103 appropriately classifies packets received from the upper layer protocols according to the criterion such as the service type, maps the classified packets to their associated MAC flows, and delivers the mapped packets to the MAC sublayer 101 via a MAC-Service Access Point (MAC-SAP) 102. In addition to such a basic function, the 802.16 standard adds a so-called PHS function to the convergence sublayer 103 so that the convergence sublayer 103 removes an unnecessary part, due to its overlapping, from an upper layer header part in a PDU received from the upper layers and transmits only the remaining part, thereby increasing resource efficiency.

With reference to FIGS. 2A and 2B, a detailed description will now be made of an operation process of the PHS scheme. FIGS. 2A and 2B are flowcharts illustrating operations of a transmitter and a receiver for PHS-based header compression/decompression proposed in the IEEE 802.16 system. With reference to FIG. 2A, an operation of a transmitter will first be described below.

If a packet arrives from an upper layer in step 201, a transmitter proceeds in step 202 where it classifies the packet and reads the following five kinds of values in order to compress a header of the corresponding packet.

a. PHSF(PHS Field)

b. PHSI(PHS Index)

c. PHSM(PHS Mask)

d. PHSS(PHS Size)

e. PHSV (PHS Verify)

The five kinds of values are predefined by a base station (BS) and a subscriber station (SS) during call setup. When the PHSV value is set, the transmitter performs packet verification. However, when this value is not set, the transmitter does not use the verification process. Therefore, the transmitter checks the PHSV value in step 203 to determine whether packet verification is necessary. If the packet verification is necessary, the transmitter proceeds to step 204, and otherwise, proceeds to step 206.

In step 204, the transmitter verifies the packet using PHSF and PHSM values. After the verification, the transmitter determines in step 205 whether the packet has passed the verification. If it is determined in step 205 that the verification was successful, that is the packet has passed the verification, the transmitter proceeds to step 206. Otherwise, the transmitter proceeds to step 207.

That is, the transmitter proceeds to step 206 when it does not perform the packet verification or when the verification, if performed, is successful. In step 206, the transmitter removes bytes corresponding to the header using the PHSM value and sets a PHSI value. However, in step 207, the transmitter sets the PHSI value to ‘0’ and does not perform the header removal (or header compression). After setting the PHSI value in step 206 or 207, the transmitter proceeds to step 208 where it adds the PHSI value to the packet received from the upper layer, and provides the PHSI-added packet to a MAC-SAP 102 in step 209.

Next, with reference to FIG. 2B, an operation of a receiver will be described below.

If the packet configured in the foregoing manner arrives wirelessly at a receiver, a MAC-SAP 102 receives the packet, configures a PDU using the received packet, and delivers the PDU to its upper convergence sublayer 103, in step 210. Upon arrival of the PDU packet, the convergence sublayer 103 proceeds to step 211 where it checks a connection ID of the packet and extracts a PHSI value therefrom. Thereafter, in step 212, the receiver reads PHSF, PHSI, PHSM, PHSS and PHSV values of the received packet. Thereafter, in step 213, the receiver reconfigures the contents removed from the header during transmission, using the read values. In this manner, even though the transmitter removes a header, the receiver can completely receive the corresponding packet. After reconfiguring the header, the receiver proceeds to step 214 where it provides the header-recovered packet to an upper layer via a CS-SAP 104.

With reference to FIG. 3, a description will now be made of a method for removing and restoring a header. FIG. 3 is a conceptual diagram for a description of a header removing/restoring scheme based on a PHS scheme in the IEEE 802.16 system.

A transmitter removes a part of a header 311 in a transmission packet 301 using its PHSM value 302. For example, if particular bits of the PHSM are set to ‘1’, the scheme illustrated in FIG. 3 removes a corresponding byte of the header 311 and transmits only the remaining part. Therefore, the transmitter determines whether to transmit the header using the PHSM value. The remaining part after the header removal, that is an actual transmission header 303, includes the parts where bits of the PHSM are not set to ‘1’.

Therefore, a packet transmitted in the wireless section becomes a packet 304 having a simplified header. Upon receiving the transmitted packet, a receiver must restore the header.

Upon receiving the packet 304 having the simplified header through the wireless section, the receiver must restore the header. Therefore, the receiver determines the part to be restored using a PHSM 305 previously stored therein. That is, the part where bits of the PHSM are set to ‘1’ becomes the part to be restored. After determining the part to be restored, the receiver can obtain a restored original header 317 by combining a part 306 previously stored therein with the received part 304. The receiver delivers the restored header 317 to an upper layer in a transmission packet 307.

Different packet formats for a convergence sublayer 103 are illustrated in FIG. 4 for a case where the header removing is performed and for another case where the header removing is not performed.

When the header removing is not performed, the convergence sublayer 103 attaches a PHSI=0 401 to a head of an IP packet 402 and delivers the result packet to a MAC layer. However, when the header removing is performed, the convergence sublayer 103 sets a PHSI to an appropriate non-zero value (PHSI≠0), attaches the PHSI≠0 403 to a head of a header-removed (or header-compressed) IP packet 404, and delivers the result packet to the MAC layer.

However, the convergence sublayer 103 defined in the current IEEE 802.16 standard has the following two problems. First, the amount of the header that the PHS scheme, which is the header length reduction scheme supported in the convergence sublayer 103, can reduce is extremely small, making it difficult to efficiently use wireless resources. Second, other header compression schemes, except for the PHS scheme performed in the convergence sublayer 103, are not supported. These problems will be described in detail herein below.

PHS Performance Problem

The PHS scheme supported in the IEEE 802.16 standard can also reduce a length of IP/UDP/RTP headers to be transmitted in a wireless section. However, the amount of the header that can be reduced through the PHS scheme is not larger than the amount of the header that can be reduced through such header compression schemes as Robust Header Compression (ROHC) or Enhanced Compressed Real-Time Protocol (ECRTP). A description will now be made of a method for performing header removing on an RPT protocol header having a format of FIG. 5, using the PHS scheme.

FIG. 5 is a diagram illustrating an internal format of a general RTP header, and FIG. 6 is a diagram illustrating an internal format obtained after performing header removing on the general RTP header using the PHS scheme.

A description will now be made of a method for removing a part of the RTP header of FIG. 5 using the PHS scheme as shown in FIG. 6. In the RTP header, the parts corresponding to a ‘Sequence Number’ field 607 having a value increased by 1 from a corresponding field value of a previous packet and a ‘Time Stamp’ field 608 possibly having a value different from that in the previous packet cannot be removed. Therefore, these parts should always be transmitted. Although a ‘Payload Type’ field 606 can theoretically be removed because its value remains unchanged once a Voice over Internet Protocol (VoIP) call is set up, it is impossible to remove the ‘Payload Type’ field 606 because a value of a ‘Marker’ field 605 that shares the same byte with the ‘Payload Type’ field 606 and corresponds to the most significant bit (MSB) may possibly be subject to change on a packet-by-packet basis.

Therefore, it is impossible to remove the ‘Payload Type’ field 606 with the PHS scheme that operates on a byte-by-byte basis.

As a result, the fields that can be removed through the PHS scheme include a total of 5 bytes of a ‘Version’ field 601, a ‘P’ field 602, an ‘X’ field 603, a ‘CC’ field 604, and a ‘Synchronization Source Identifier’ field 609. A length of the RTP header actually transmitted through the wireless section after removing the header indicated by a PHSM becomes 7 bytes.

Existing Header Compression Scheme Support Problem

In order to increase transmission efficiency in the wireless section, it is necessary to use other header compression schemes instead of the PHS scheme defined in the IEEE 802.16 standard. However, a convergence sublayer 103 defined in the current IEEE 802.16 standard cannot support such header compression schemes. The convergence sublayer 103, after receiving packets provided from its upper IP layer, extracts such information as an IP address, a UDP port number, and a service type (TOS or DSCP) from IP, UDP, and RTP headers, and maps packets received from its upper layer to their appropriate flows of a MAC layer 101 based on the extracted information. The process of extracting necessary information from the header, distinguishing packets and mapping the packets to flows of the MAC layer will be referred to as a “classification process.” When transmitting the full header without applying the PHS scheme or other header compression schemes, the convergence sublayer 103 extracts necessary information from the IP/UDP/RTP headers received from the upper layer, and provides both of the header and the payload to the MAC layer 101, to allow the MAC layer 101 to transmit the packet in the wireless section. However, when using the PHS scheme, the convergence sublayer 103 extracts necessary information from the IP/UDP/RTP headers received from the upper layer in the classification process, removes an unnecessary header part according to a PHSM value predefined during call setup, and provides the remaining header and the payload to the MAC layer 101, to allow the MAC layer 101 to transmit the packet in the wireless section.

Because the convergence sublayer 103 uses the foregoing header compression scheme, it has difficulty in applying another header compression scheme. That is, if the convergence sublayer 103 uses another header compression scheme, it cannot determine whether a received packet is a compressed one or not. Even though the convergence sublayer 103 can determine whether a received packet is a compressed one or not, the convergence sublayer 103 cannot extract necessary information from the compressed header in the classification process unless it decompresses the compressed header.

### SUMMARY OF THE INVENTION

It is, therefore, an object of the present invention to provide a header compression apparatus and method having a protocol layer configuration capable of supporting a header compression ratio which may be higher than that in an IEEE 802.16 system.

It is another object of the present invention to provide a header compression apparatus and method which is compatible with other header compression schemes in an IEEE 802.16 system.

It is a further object of the present invention to provide an apparatus and method for increasing efficiency of a wireless band through header compression in a broadband wireless communication system.

According to one aspect of the present invention, there is provided a transmission apparatus for compressing headers in a broadband wireless communication system. The apparatus comprises a header compression protocol layer for, upon receiving a packet to which a real-time transport protocol (RTP) header, a user datagram protocol (UDP) header, and an Internet protocol (IP) header are added, from an upper layer, transmitting the received packet without compressing the headers at initial transmission, and from the next transmission, compressing the headers according to a compression scheme provided in Internet technology; and a header compression convergence sublayer for classifying the packet according to initial-header information received from the header compression protocol layer, storing mapping information for the packet classification, and performing packet classification on a header-compressed packet using the mapping information.

According to another aspect of the present invention, there is provided a transmission method for compressing headers in a broadband wireless communication system. The method comprises, upon receiving a packet to which a real-time transport protocol (RTP) header, a user datagram protocol (UDP) header, and an Internet protocol (IP) header are added, from an upper layer, transmitting the received packet without compressing the headers during initial transmission. The packet is classified according to header information during the initial transmission, and mapping information for the packet classification is stored. The headers are compressed according to a compression scheme, provided in Internet technology, that extracts information that is not subject to change every packet, in the header information received from the upper layer after the initial transmission and removes headers according to the extracted information. Packet classification is performed on the compressed headers using the stored mapping information, and the classified packet is transmitted.

### BRIEF DESCRIPTION OF THE DRAWINGS

The above and other exemplary objects, features and advantages of the present invention will become more apparent from the following detailed description when taken in conjunction with the accompanying drawings in which like reference numerals will be understood to refer to like parts, components and structures, where:

FIG. 1 is a diagram illustrating a protocol configuration for a wireless communication network for providing IP-based packet voice service in an IEEE 802.16 system;

FIGS. 2A and 2B are flowcharts illustrating operations of a transmitter and a receiver for PHS-based header compression/decompression proposed in the IEEE 802.16 system;

FIG. 3 is a conceptual diagram for a description of a header removing/restoring scheme based on a PHS scheme in the IEEE 802.16 system;

FIG. 4 is a diagram illustrating packet formats for a convergence sublayer in the IEEE 802.16 system according to the prior art;

FIG. 5 is a diagram illustrating an internal format of a general RTP header;

FIG. 6 is a diagram illustrating an internal format obtained after performing header removing on the general RTP header using the PHS scheme;

FIG. 7 is a diagram illustrating an internal format obtained after performing header removing on the general RTP header of FIG. 5 using an ROHC or ECRTP scheme;

FIG. 8 is a diagram illustrating a protocol configuration for header compression in a broadband wireless communication system according to an exemplary embodiment of the present invention;

FIG. 9 is a diagram illustrating a format of a packet, a header of which is compressed according to an exemplary embodiment of the present invention; and

FIGS. 10A and 10B are flowcharts illustrating a header compression/decompression process according to an exemplary embodiment of the present invention.

### DETAILED DESCRIPTION OF EXEMPLARY EMBODIMENT

Certain exemplary embodiments of the present invention will now be described in detail with reference to the annexed drawings. In the drawings, the same or similar elements are denoted by the same reference numerals even though they are depicted in different drawings. In the following description, a detailed description of known functions and configurations incorporated herein has been omitted for clarity and conciseness.

Exemplary embodiments of the present invention provide a function, a packet format and an operation process of a new convergence sublayer for supporting various header compression techniques.

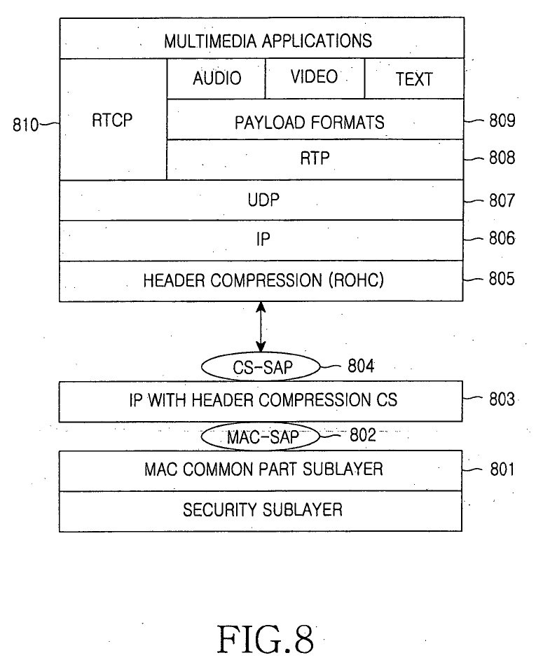

FIG. 8 is a diagram illustrating a protocol configuration for header compression in a broadband wireless communication system according to an embodiment of the present invention.

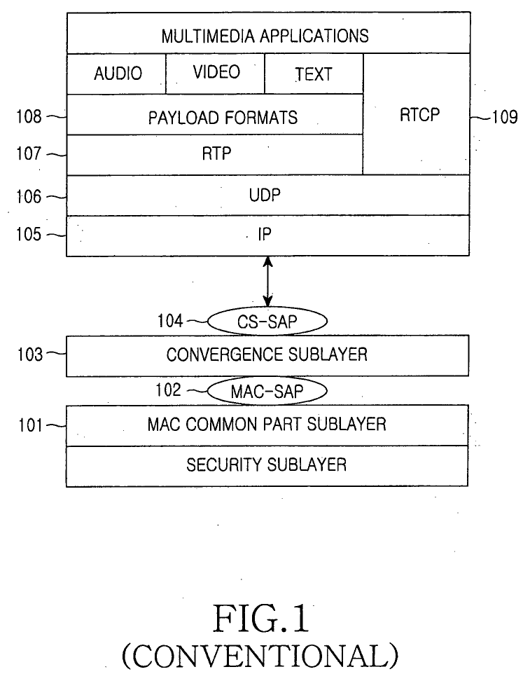

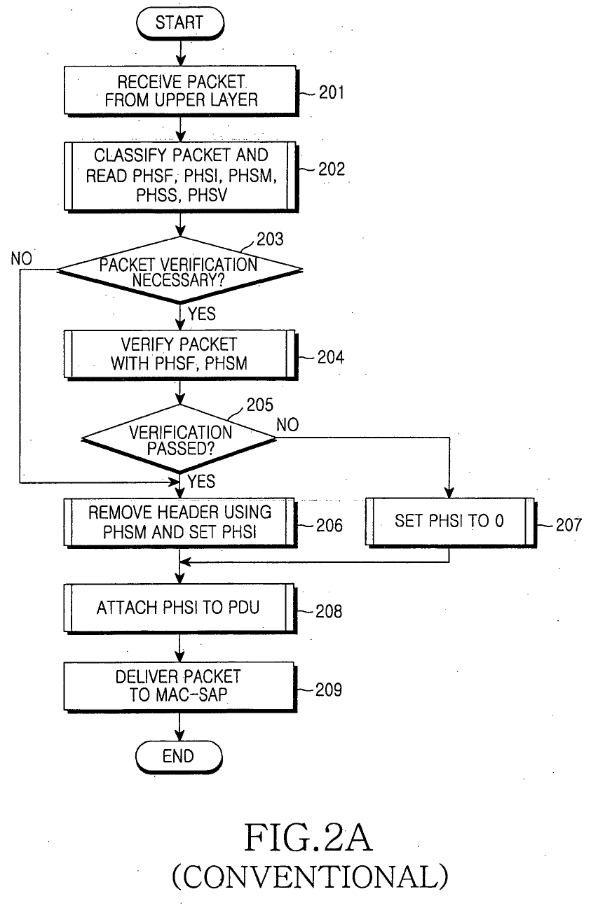

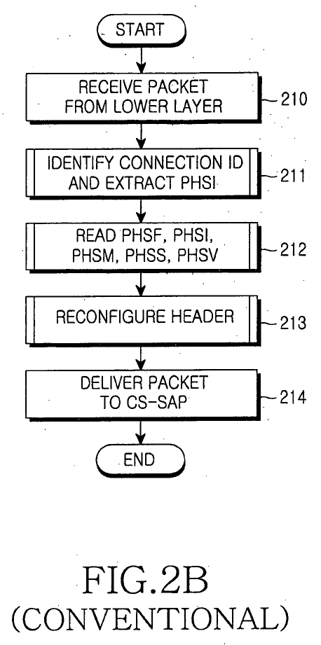

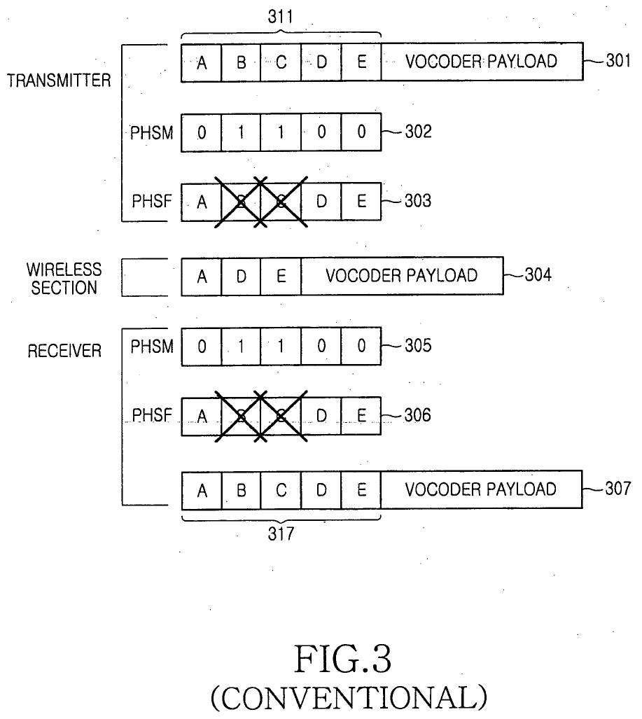

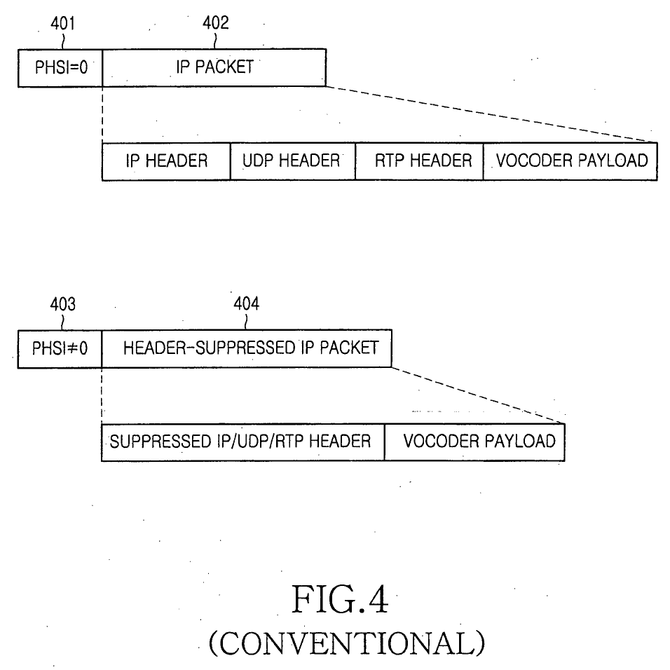

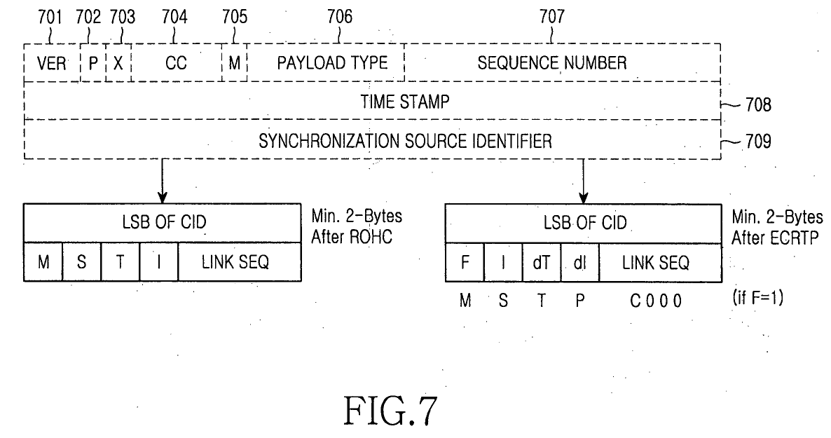

The protocol configuration will be described from its upper layer. Data delivered from a Multimedia Applications layer to its lower layers, as described in connection with FIG. 1, includes voice, video and text data. Such data, which is pure data, is configured in payload formats 809 and then delivered to a Real-time Transport Protocol (RTP) layer 808. Then the RTP layer 808 adds an RTP header to the received payload format data, and provides the RTP header-added data to a User Datagram Protocol (UDP) layer 807. An RTP Control Protocol (RTCP) layer 810 serves to provide control information of the RTP layer 808. The UDP layer 807 converts the received data into UDP format data, adding a UDP header thereto. The UDP header-added data is delivered to an IP layer 806, and the IP layer 806 further adds an IP header thereto and delivers the IP header-added data to a header compression protocol layer 805 according to an exemplary embodiment of the present invention. The header compression protocol layer 805 can use any one of header compression schemes having a header higher compression ratio than that of the PHS scheme. Such header compression schemes can include, but are not limited to, a Robust Header Compression (ROHC) scheme or an Enhanced Compressed RTP (ECRTP) scheme recommended by Internet Engineering Task Force (IETF), another standard organization. Before a further description of FIG. 8 is given, a method for compressing a header according to the ROHC scheme or the ECRTP scheme will be described in brief with reference to FIG. 7. A description of FIG. 7 will be made in brief, because the exemplary, but not limiting, header compression method illustrated therein is well known to those skilled in the art.

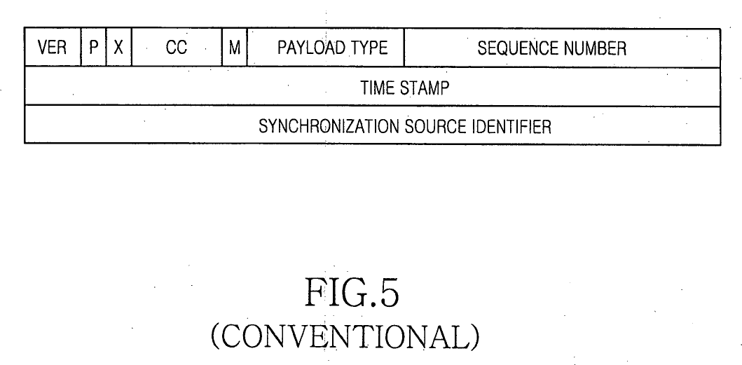

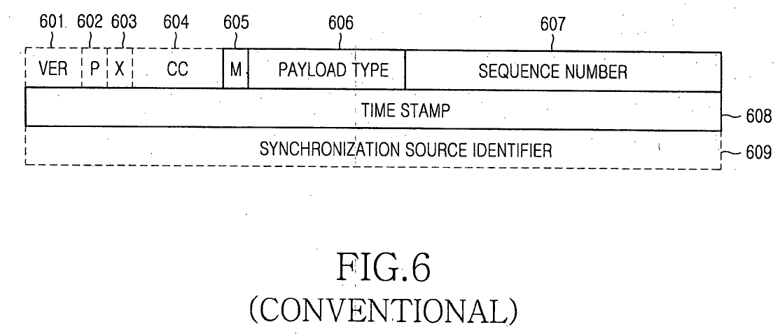

FIG. 7 is a diagram illustrating an internal format obtained after performing header removing on the general RTP header of FIG. 5 using the ROHC or ECRTP scheme.

In FIG. 7, a Compressed_RTP scheme based on the ROHC header compression scheme is used. A 12-byte RTP header shown in FIG. 7 can be compressed into a header of a minimum of 2 bytes. Among the fields shown in FIG. 7, a ‘Version’ field 701, a ‘P’ field 702, an ‘X’ field 703, a ‘CC’ field 704, a ‘Synchronization Source Identifier’ field 709, and a ‘Payload Type’ field 706 remain unchanged once they are set during a VoIP call setup. Therefore, these fields are omitted not to be transmitted in the wireless section, and can be restored at a destination ROHC protocol entity using predetermined values.

For the fields whose values are subject to change, such as a ‘Sequence number’ field 707, a ‘Time stamp’ field 708, and a ‘Marker’ field 705, the Compressed_RTP scheme transmits flags indicating whether their corresponding field values are changed. When the three field values are changed to the values other than their expected values, the scheme adds new changed values to the rear thereof if necessary. For example, the ‘Sequence number’ field 707 generally increases by 1 every packet. In this case, an ‘S’ flag of the Compressed_RTP header is set to ‘0’. Therefore, upon receiving such a packet, a receiver restores the field with a ‘previous Sequence number+1’ value at the ROHC protocol entity. However, if the ‘Sequence number’ increases to a value larger than 1 for some reason, the scheme sets the ‘S’ flag to ‘1’ and further adds a field indicating the corresponding increment to the header.

The ECRTP scheme is similar in operation to the ROHC scheme, but adds a flag to the compressed header format. When an RTP header is compressed using the ECRTP scheme, the 12-byte RTP header is compressed into a header of a minimum of 2 bytes, and when an additional flag is used, the 12-byte RTP header is compressed into a 3-byte header. Compared with the PHS scheme that shows an RTP header compression ratio of a maximum of 41.67%, the ROHC or ECRTP header compression technique shows an expected header compression ratio of a maximum of 83.33%.

Turning back to FIG. 8, an exemplary implementation of an embodiment of the present invention compresses packet headers using one of the header compression schemes having a high compression ratio. The header-compressed data is delivered to a Convergence Sublayer service Access Point (CS-SAP) 804. The CS-SAP 804 delivers the header-compressed packet to a Header compression convergence sublayer 803 newly defined according to an exemplary embodiment of the present invention. The new header compression convergence sublayer 803 classifies packets received from its upper layers according to predetermined criteria. The new header compression convergence sublayer 803 is configured to be able to classify received packets even with the already compressed data.

The criteria used for the packet classification include, but are not limited to, an IP address of a transmitter, an IP address of a receiver, a UDP port, an IP service type, and so on. These values are included in the IP and UDP headers, and an exemplary method for classifying packets at the new header compression convergence sublayer 803 will be described below. After classifying the received packets, the new header compression convergence sublayer 803 maps the classified packets to their appropriate flows, adds connection identifiers (IDs) thereto, and delivers the connection ID-added packets to its lower Medium Access Control (MAC) common part sublayer 801.

The new header compression convergence sublayer 803 supports the header compression techniques used in an IP network. According to an exemplary implementation, a packet in which a header is attached to the payload 809 generated in a voice codec based on the protocol configuration of FIG. 8, while passing through the RTP layer 808, the UDP layer 807, and the IP layer 806, is delivered to a lower layer after being header-compressed through the header compression protocol layer 805. The packet is delivered to the new header compression convergence sublayer 803.

The new header compression convergence sublayer 803 classifies the packets received through the header compression protocol by referring to Classifier.

When using the header compression protocol, the header compression convergence sublayer 803 cannot directly extract information to be used as the Classifier from the header because the IP/UDP/RTP headers are compressed. Therefore, the header compression convergence sublayer 803 uses mapping relations between Session Context ID, Service Flow ID and Connection ID of the packet. That is, in the case of the header compression protocol, at first, the header compression convergence sublayer 803 should necessarily transmit the full header through the wireless section. Therefore, at this time, the header compression convergence sublayer 803 extracts information necessary for Classifier, that is, IP addresses, UDP port number, IP service type, and so on, and maps them to appropriate Service Flows. Further, the header compression convergence sublayer 803 adds a Connection ID to a newly generated packet call.

When using the header compression scheme, the header compression convergence sublayer 803 adds Context IDs to the compressed headers in order to distinguish packets in each session. The header compression convergence sublayer 803 previously stores mapping relations between Service Flow ID, Connection ID and Context ID, determined through a first packet header. In the process of classifying the next header-compressed packet received from the upper layer, the header compression convergence sublayer 803 extracts only the Context ID of the header-compressed packet, instead of extracting Classifier information, maps the extracted Context ID to appropriate Service Flow ID and Connection ID according to the previously stored mapping relation information, and delivers the mapping result to the MAC common part sublayer 801 via a MAC-Service Access Point (MAC-SAP) 802.

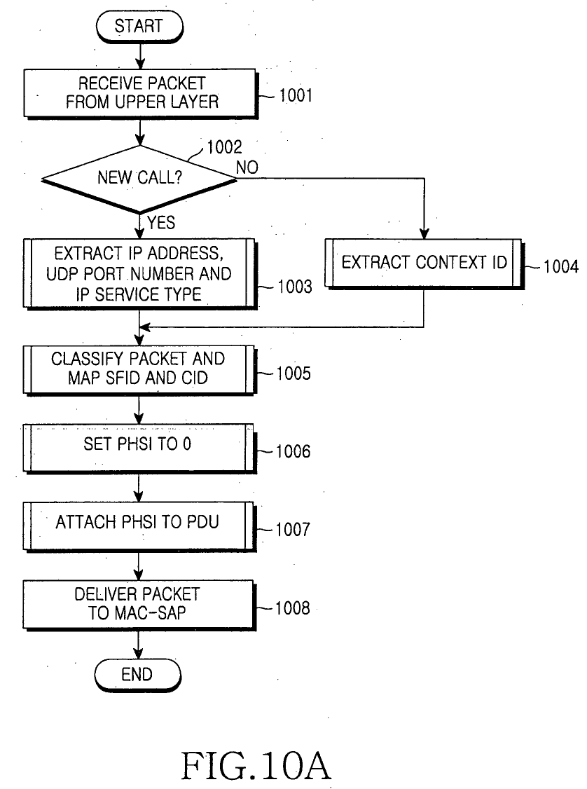

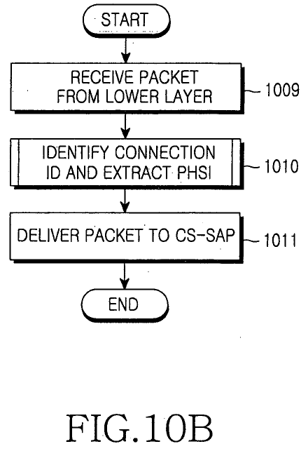

Through this process, the MAC common part sublayer 801 can deliver the header-compressed packet over the air. Similarly, an operation of the receiver is performed in the reverse process of the foregoing process, and a description thereof will be made with reference to FIGS. 10A and 10B where description of certain details which will be understood by skilled artisans has not been repeated for clarity and conciseness.

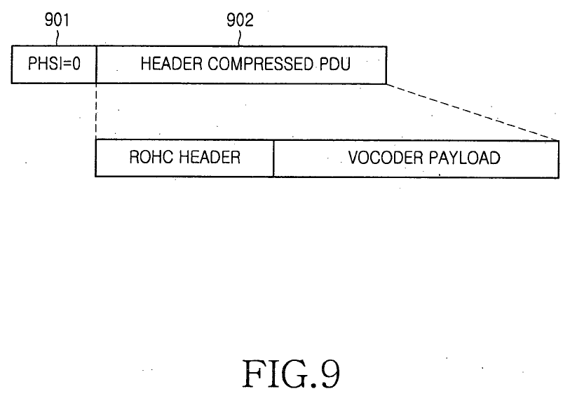

FIG. 9 is a diagram illustrating a format of a packet whose header is compressed according to an exemplary embodiment of the present invention.

Because the new header compression convergence sublayer 803 supports the header compression protocol, it does not separately support the PHS scheme. Therefore, the header compression convergence sublayer 803 sets a PHSI=0 901, attaches the PHSI=0 to a head of a header-compressed IP packet 902, and provides the result packet to the MAC common part sublayer 801. In an exemplary implementation as shown in FIG. 9, reference numeral 901 indicates whether data verification is necessary, as described above, and reference numeral 902 indicates a header-compressed PDU. FIG. 9 shows an exemplary header compressed by the ROHC scheme. Therefore, the header-compressed PDU 902 includes an ROHC header and a vocoder payload.

FIGS. 10A and 10B are flowcharts illustrating a header compression/decompression process according to an exemplary embodiment of the present invention. With reference to FIGS. 10A and 10B, a detailed description will now be made of a header compression/decompression process according to an exemplary embodiment of the present invention.

Upon receiving transmission packet data from an upper layer in step 1001, a transmitter determines in step 1002 whether the received packet data is for a new call. If the received packet data is for a new call, the transmitter proceeds to step 1003. Otherwise, if the received packet data is not for a new call, the transmitter proceeds to step 1004. If the packet received from the upper layer is for a new call, a new header compression convergence sublayer 803 extracts an IP address, a UDP port number, and an IP service type in step 1003. The header compression convergence sublayer 803 extracts such information in order to classify service. After extracting the information, the header compression convergence sublayer 803 proceeds to step 1005 where it classifies the packet and maps the classified packet to its associated Service Flow ID and Context ID. Thereafter, in step 1006, the header compression convergence sublayer 803 sets a PHSI value to ‘0’. That is, because the header compression convergence sublayer 803 does not use the conventional PHS scheme, it increments the header or sets the PHSI value to ‘0’. Thereafter, in step 1007, the header compression convergence sublayer 803 adds the generated PHSI value to a PDU. The PHSI-added PDU is equal in format to that shown in FIG. 9. Thereafter, in step 1008, the header compression convergence sublayer 803 delivers the generated packet to a MAC-SAP layer 802.

However, if it is determined in step 1002 that the received packet is not for a new call, the header compression convergence sublayer 803 proceeds to step 1004 where it extracts a Context ID generated through the foregoing process. Thereafter, the header compression convergence sublayer 803 performs step 1005 and its succeeding steps.

Next, with reference to FIG. 10B, a description will now be made of an operation of a receiver according to an exemplary embodiment of the present invention.

The data transmitted over the air is received at the receiver through a lower layer. Upon receiving packet data from a lower layer in step 1009, a header compression convergence sublayer 803 proceeds to step 1010 where it identifies a Connection ID and extracts a PHSI value from the received packet data. That is, the header compression convergence sublayer 803 delivers the received packet to an upper layer via a CS-SAP 804 without reconfiguring its header. Then a header compression protocol layer 805 included in the upper layer according to an exemplary embodiment of the present invention restores the compressed header.

As can be understood from the foregoing description, exemplary implementations of the present invention allow a wireless communication system that provides packet voice service based on an IP network to use various header compression schemes. In this manner, the wireless communication system can reduce the amount of header information transmitted in the wireless section without quality deterioration by applying header compression schemes having higher performance than that of the conventional header compression technique of the PHS. Waste of resources in the wireless section can be reduced by reducing the amount of header information transmitted in the wireless section. The reduction in the amount of header information transmitted in the wireless section may also contribute to an increase in resource efficiency.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A transmission apparatus for compressing headers in a broadband wireless communication system, the apparatus comprising:
a header compression protocol layer for transmitting a received packet without compressing at least one header added from an upper layer to the received packet at initial transmission, and from the next transmission, compressing the at least one header according to a compression scheme; and
a header compression convergence sublayer for classifying the packet according to initial-header information received from the header compression protocol layer, storing mapping information for the packet classification, and performing packet classification on a header-compressed packet using the mapping information.

2. The transmission apparatus of claim 1, wherein the compression scheme comprises a robust header compression (ROHC) scheme.

3. The transmission apparatus of claim 1, wherein the compression scheme comprises an enhanced compressed RTP (ECRTP) scheme.

4. The transmission apparatus of claim 1, wherein the header compression convergence sublayer stores mapping relation information between a context identifier (ID), a service flow ID and a connection ID during initial packet transmission, extracts the connection ID from the at least one compressed header for the next packet, and classifies the packet according to the stored mapping information.

5. The transmission apparatus of claim 1, wherein the header compression protocol layer sets a payload header suppression identifier (PHSI) to a value indicating that the at least one header is not compressed.

6. An apparatus for receiving a packet comprising a header compressed according to a compression scheme, the apparatus comprising:
a header compression convergence sublayer for extracting a connection identifier (ID) from information received from a lower layer after being transmitted over a wireless section, and extracting a payload header compression index value used in the broadband wireless communication system; and
a header compression protocol layer for previously storing information that is not subject to change every packet, in header information received during initial packet reception, decompressing the next received packet by adding previously stored information to header information delivered from the header compression convergence sublayer, and delivering the decompressed packet to an upper layer.

7. A transmission method for compressing headers in a broadband wireless communication system, the method comprising the steps of:
upon receiving a packet to which at least one header is added from an upper layer, transmitting the received packet without compressing the at least one header during initial transmission;
classifying the packet according to header information during the initial transmission, and storing mapping information for the packet classification;
compressing the at least one header according to a compression scheme that extracts information that is not subject to change every packet, in the header information received from the upper layer after the initial transmission and removes the at least one header according to the extracted information;
performing packet classification on the at least one compressed header using the stored mapping information; and
transmitting the classified packet.

8. The transmission method of claim 7, wherein the compression scheme comprises a robust header compression (ROHC) scheme.

9. The transmission method of claim 7, wherein the compression scheme comprises an enhanced compressed RTP (ECRTP) scheme.

10. The transmission method of claim 7, wherein the mapping information for the packet classification comprises mapping relation information between a context identifier (ID), a service flow ID and a connection ID during initial packet transmission.

11. The transmission method of claim 10, wherein the packet classification using the stored mapping information for the compressed headers comprises classifying the packet according to mapping information obtained by extracting the connection ID from the compressed header.

12. The transmission method of claim 7, wherein a payload header suppression identifier (PHSI) comprises a value indicating that the headers are not compressed.

13. A method for receiving a packet comprising a header compressed according to a compression scheme, the method comprising the steps of:
extracting a connection identifier (ID) from information received from a lower layer after being transmitted over a wireless section, and extracting a payload header compression index value used in the broadband wireless communication system; and
previously storing information that is not subject to change every packet, in header information received during initial packet reception, decompressing the next received packet by adding the previously stored information to header information provided from a header compression convergence sublayer, and transmitting the decompressed packet to an upper layer.

14. The transmission apparatus of claim 1, wherein the at least one header comprises at least one of a real-time transport protocol (RTP) header, a user datagram protocol (UDP) header, and an Internet protocol (IP) header.

15. The transmission method of claim 7, wherein the at least one header comprises at least one of a real-time transport protocol (RTP) header, a user datagram protocol (UDP) header, and an Internet protocol (IP) header.
